(19) United States
(12) Patent Application Publication
(10) Pub. No.: US 2002/0026318 A1
(43) Pub. Date: Feb. 28, 2002

(54) Method of synthesizing voice

(76) Inventors: Koji Shibata, Saitama (JP); Shinichi Suzuki, Saitama (JP)

Correspondence Address: MORGAN, LEWIS & BOCKIUS, 1800 M STREET NW, WASHINGTON, DC, 20036-5869, US

(21) Appl. No.: 09/925,960

(22) Filed: Aug. 10, 2001

(30) Foreign Application Priority Data
Aug. 14, 2000 (JP) 2000-245863

(51) Int. Cl. G10L 13/00

(52) U.S. Cl. 704/258

(57) ABSTRACT

A voice synthesization method for only vocalizing character information that an audience wants to hear, when the audience receives character information transmitted via digital broadcasting. The method recognizes tags and character information contents included in character information transmitted via the digital broadcasting, and compares them with predetermined tags and character information which the audience set beforehand. The method determines whether the character information transmitted via the digital broadcasting should undergo voice synthesis, on the basis of comparison result.

### BACKGROUND OF THE INVENTION

1. Field of the Invention

The present invention relates to a voice synthesization method for converting character information included in information transmitted via a communication medium, such as a digital broadcasting system, into a corresponding synthesized voice.

2. Description of the Related Art

With a conventional broadcasting technique, image or video information is only transmitted. Dramatic progress in a digital broadcast technology in recent years, however, makes it possible to transmit character information together with the image information to complement the image information, and this is called digital broadcasting and is popularizing more and more. For example, the digital broadcasting is utilized when traffic information in the form of character is transmitted together with a road map information in the form of image, and when weather information in the form of character is transmitted with a weather map in the form of image.

In case of a data receiving device installed on a vehicle, which requires a driver to listen to broadcasted information while the driver is driving a car, it is difficult for the driver to take advantage of character information delivery because the driver should always pay attention to a forward view to drive the car safely.

In order to eliminate this drawback, Japanese Patent Application Laid-Open Publication No. 9-251373 teaches a method and apparatus for synthesizing a voice such that character information carried on a broadcasting medium is converted to voice information by means of a synthesized voice. This prior art technique functions on the following principle; a data receiving device detects a vocalization command, that indicates which part of the character information should undergo the voice synthesis process, presented in the character information by a data sending party (broadcasting party), and only converts such part of the character information into the voice information.

Accordingly, which part of the character information should be vocalized is always decided by the broadcasting party. In other words, the broadcast receiving party's intention is not concerned. Further, the character information accompanied with and without the voice information is mixedly broadcasted since the vocalization instructions are given by appending the vocalizing command to the character information. This makes the data receiving device have a complicated structure.

### OBJECTS AND SUMMARY OF THE INVENTION

The present invention was developed to overcome the above described problems, and its primary object is to provide a voice synthesization method that allows a data receiving party to have a synthesized sound for desired portion(s) of the transmitted character information.

According to one aspect of the present invention, there is provided a voice synthesization method for producing a synthesized sound that corresponds to character information included in transmitted information written in a programming language, the transmitted information including the character information and tags adapted to reserve the character information, the method comprising the steps of: A) recognizing a tag in the character information; B) comparing the tag recognized in step A with a predetermined tag; and C-1) producing a synthesized sound from the character information reserved by the recognized tag only when the two tags match each other in step B or C-2) producing a synthesized sound from character information except for those reserved by the recognized tag only when the two tags match each other in step B.

### BRIEF DESCRIPTION OF THE DRAWINGS

FIG. 1 is a block diagram showing a structure of a data receiving device installed on a vehicle according to an embodiment of the present invention;

FIGS. 2A to 2C illustrate examples of display screen and list of character information transmitted by digital broadcasting respectively;

FIG. 3 illustrates a flowchart of processing executed in an operation mode 1 in the data receiving device shown in FIG. 1;

FIG. 4 illustrates a flowchart of processing executed in an operation mode 2 in the data receiving device shown in FIG. 1;

FIG. 5 illustrates a flowchart of processing executed in an operation mode 3 in the data receiving device shown in FIG. 1;

FIG. 6 illustrates a flowchart of main processing (main program) executed in an operation mode 4 in the data receiving device shown in FIG. 1; and

FIG. 7 illustrates a flowchart of sub-program executed to retrieve character to be vocalized in the operation mode 4 in the data receiving device shown in FIG. 1.

### DETAILED DESCRIPTION OF THE INVENTION

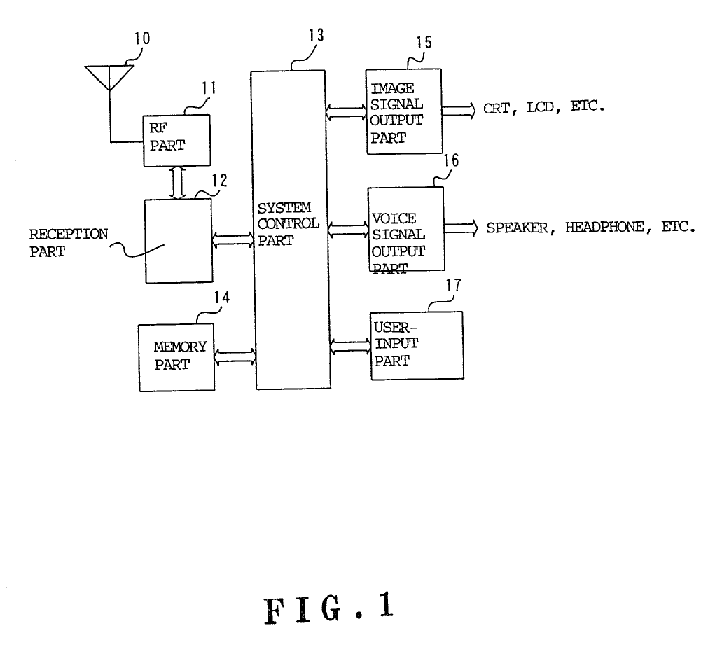

Reference is first made to FIG. 1 which illustrates a block diagram of a broadcast receiving device provided on a vehicle for carrying out a voice synthesis method of the present invention.

In FIG. 1, a data receiving antenna 10 is a small size, high gain antenna such as a rod antenna or dielectric antenna and adapted to receive digital broadcast electric wave from a broadcast station.

An RF part 11 is a circuit for performing several processing to received electric wave such as amplification, frequency conversion and wave detection of the received electric wave. The RF part 11 is a so-called front end portion in the data receiving device.

A reception part 12 is a circuit that performs all processing required to accurately reproduce the received data such as deinterleaving process to be made on the detected and demodulated data and error correction process. The reception part 12 also decodes the received data for respective channels.

A system control part 13 is primarily made up from a microcomputer (referred to as μLCPU) and controls an overall operation of the data receiving device. The μCPU executes a main program needed for a general operation of the data receiving device and various sub-programs such as a voice synthesis subroutine of the present invention in synchronization with a built-in clock. The main and subprograms are stored in a memory part 14 (will be described below).

The memory part 14 includes memory elements such as ROM (Read Only Memory) and RAM (Random Access Memory). ROM stores diverse programs needed to control the operation of the data receiving device as mentioned above, and RAM temporarily stores various kinds of calculation results during processing, various flag/register (simply referred to as “flag”) conditions which are items in making determinations during processing, and predetermined tag information and character information. Voice or sound resource data for vocalization used in the voice synthesis process is accumulated and stored as digital data in ROM or a nonvolatile RAM inside the memory part 14.

An image or video signal output part 15 is a circuit for outputting image information included in the received data to a display device such as CRT and LCD. A voice or audio signal output part 16 is a circuit for outputting voice information included in the received data and voice information produced in the voice synthesis process executed by the system control part 13 to an acoustic (or audio) device such as a speaker and headphone.

An input part 17 is an operation or control unit for a user to input various instructions, commands and information when the user operates the data receiving device, and includes a keyboard and switches such as function keys.

Character information transmitted by way of digital broadcasting is generally written by a so-called programming language defined by, for example, JIS-X-4151 such as SGML (Standard Generalized Markup Language) or HTML (Hypertext Markup Language), which is an information interchange language utilized in a data network.

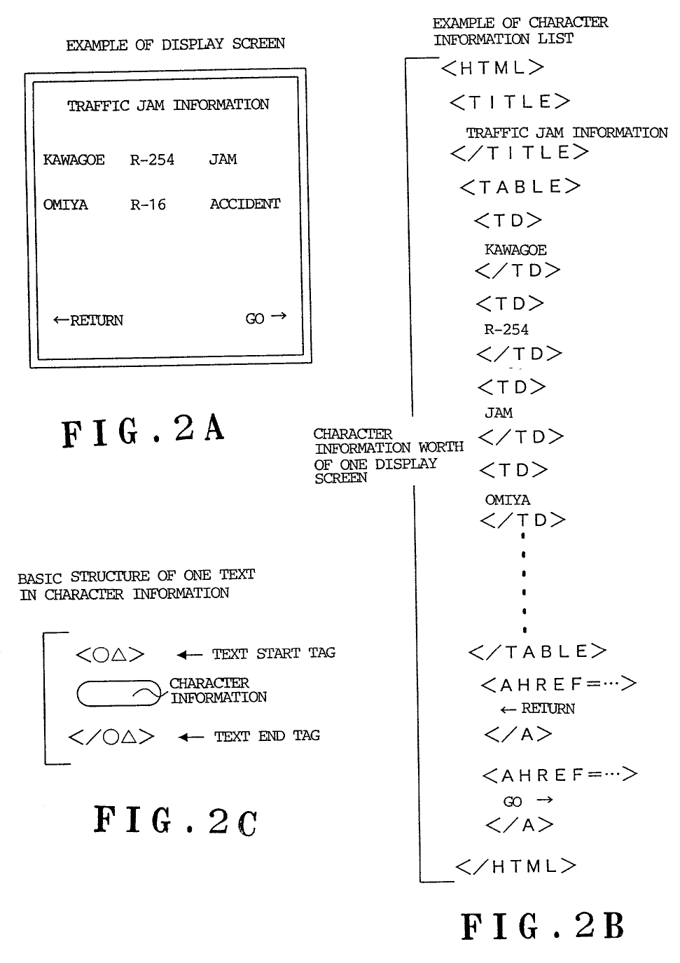

Examples of the character information carried over the digital broadcasting are shown in FIGS. 2A to 2C. This particular embodiment deals with a case where traffic information is transmitted in the form of character information. FIG. 2A illustrates a display screen that shows character information received by the data receiving device. FIG. 2B illustrates this character information written by the description language. It should be noted that HTML is employed as the description language in the illustrated embodiment, but the description language is not limited to HTML; any of other suitable description languages such as SGML, XML (Extensible Markup Language) and BML (Broadcasting Markup Language) can be used.

Each unit of the character information written in the description language is called “text”, and its structure is depicted in FIG. 2C. Each text is defined by a pair of key words (or reserved words) sandwiched by “<” and “>” which are called “tags”. Each text begins from a start tag and ends at an end tag. What is interposed between the two tags is the character information transmitted by the text concerned. It should be noted that this is referred to as “character information reserved by the tags” in this specification. Kinds of the tag change with contents of the character information. As illustrated in FIG. 2B, for instance, a tag “<TD>” is used when the character information only includes characters such as “Jam”, and a tag “<A . . . > is used when the character information includes characters and a symbol such as an arrow (e.g., “←Return”). The character structure of the text start tag is the same as that of the text end tag. The text end tag is prepared by appending “/” in front of the text start tag. In the previous examples, the text end tags are </TD> and </A . . . >.

As shown in FIG. 2B, when a plurality of texts form the character information of one-screen-worth and HTML is used as the description language, tags <HTML> and </HTML> are placed at the beginning and end of the one-page-worth character information to indicate the extent of the one-screen-worth character information.

An operation of the data receiving device shown in FIG. 1 according to the present invention will be described on the assumption that the device receives the character information shown in FIG. 2B. This embodiment can assume a plurality of operation modes, and these modes are referred to as mode 1 to mode 4 and described below.

The mode 1 will be described first. In the mode 1, predetermined tags are prepared in the memory part 14, and those reserved by such tags among the received character information do not undergo the voice synthesis. Such portion of the character information is not vocalized in this mode.

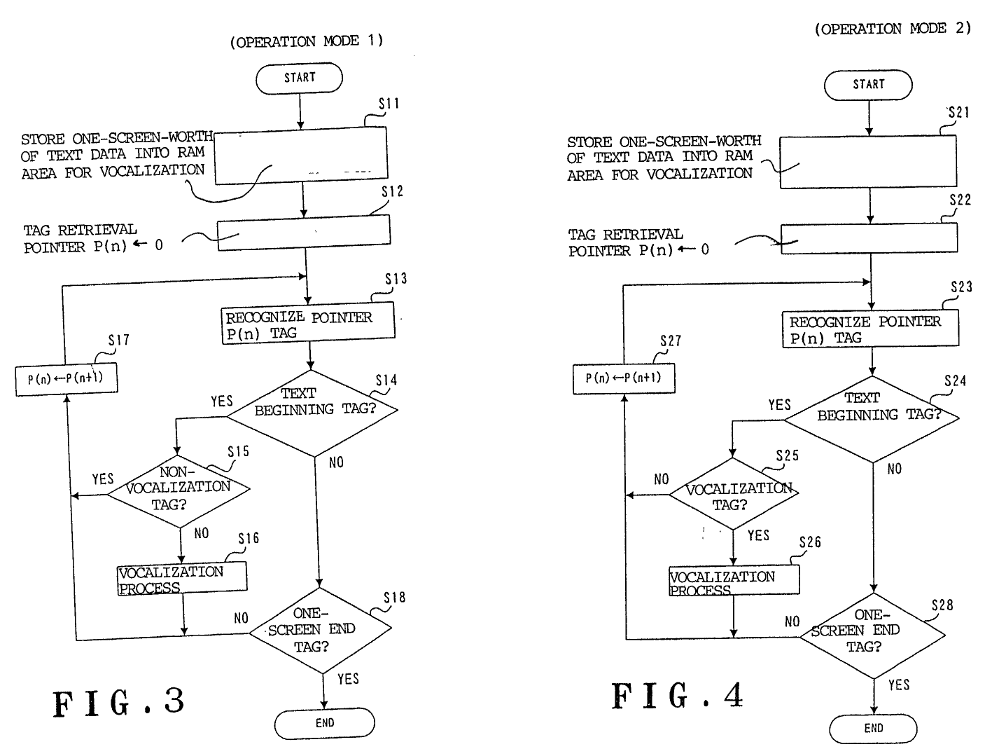

In the mode 1, the system controller 13 interrupts the main routine normally executed in synchronization with a built-in clock, and executes the subroutine shown in the flowchart of FIG. 3. Activation of this subroutine may be initiated in response to, for example, an interruption signal generated upon pressing a vocalization button in the operation unit 17 by a user. Alternatively, it may be triggered when the system controller 13 receives data of one-screen-worth from the data reception unit 12, or the system controller 13 supplies one-screen-worth of data to the image signal output unit 15.

In this subroutine, the system controller 13 first stores the text data of one-screen-worth shown in FIG. 2B into a certain area in RAM (referred to as RAM area) for vocalization in the memory unit 14 (Step 11). Subsequently, the system controller 13 prepares a register (i.e., a tag retrieval pointer P(n)) in the RAM area, and sets a value n in the register to an initial value zero (n=0) (Step 12).

After the above described preparation, the system controller 13 only looks at the tag data in the text data of one-screen-worth stored in RAM, and retrieves then'th tag among those present in the one screen to identify the content of the tag (Step 13). It should be noted that P(n) is set to its initial value, i.e., P(0) (n=0) as mentioned above, immediately after the subroutine is initiated. The system controller 13, therefore, retrieves from the first tag (i.e., <HTML>) in the text data of one-screen-worth shown in FIG. 2B.

The system controller 13 retrieves and identifies the n'th tag at Step 13. If it determines, as a result of the recognition at Step 13, that the tag content is a text beginning tag (Step 14), then the program proceeds to Step 15. The system controller 13 then determines whether the tag content is a predetermined non-vocalization tag.

The predetermined non-vocalization tag may be fixedly input to a certain area in ROM of the memory unit 14 by a manufacturer of the data receiving device beforehand during a manufacturing process, or may be input into a certain area in the nonvolatile RAM of the memory unit 14 by a user who operates the keyboard on the operation unit 17. In this embodiment that deals with the character information shown in FIG. 2B, <HTML>, <TABLE> and <A . . . > are set as the non-vocalization tags by one of the just described methods in the memory unit 14.

These tags are reserved words to instruct the beginning of the display screen or a link destination of the screen so that vocalization of the character information included in the text by the voice synthesis would not accommodate the user with anything. Consequently, such tags are defined as the non-vocalization tags.

If the system controller 13 determines at Step 15 that the n'th tag is a non-vocalization tag, then the program proceeds to Step 17 to replace P(n) with P(n+1) and returns to Step 13 to repeat the above described processing. If the system controller 13 determines at Step 15 that the tag is not a non-vocalization tag, it performs the voice synthesis on the basis of the character information reserved by this tag, and outputs the obtained voice signal to the voice signal output unit 16 (Step 16). After the vocalization process, the program advances to Step 17 to add one to n of P(n) and returns to Step 13.

At Step 14, if the recognized tag is not a text beginning tag, i.e., if the tag is a text end tag represented by </ . . . >, then the program proceeds to Step 18 and the system controller 13 determines whether the tag is a one-screen-end tag </HTML>. If the tag is not the one-screen-end tag, the program proceeds to Step 17 to add one to n of P(n) and returns to Step 13 to iterate the tag content recognition for P(n+1).

If the tag is the one-screen-end tag at Step 18, it means that the tag retrieval and the character information vocalization are finished for the one-screen-worth of text data. Thus, the system controller 13 terminates the subroutine.

It should be noted that the subroutine may be terminated by a method other than the above. For example, the number of the tags included in the text data of one-screen-worth may be counted beforehand at Step 11, and the subroutine may be terminated when the tag retrieval pointer P(n) reaches this tag value.

As described above in detail, if the character information shown in FIG. 2B is received and processed by the subroutine shown in FIG. 3, the character information of “Traffic Information”, “Kawagoe”, “R-254”, “Jam”, “Omiya”, “R-16” and “Accident” is converted to voice signals by the voice synthesis in addition to the display screen shown in FIG. 2A, and these voice signals are in turn issued to the user from the speaker or headphone.

The operation mode 2 will be described next. The operation mode 2 is a mode in which predetermined tags are input in the memory unit 14 beforehand, and those among the received character information reserved by these tags are vocalized.

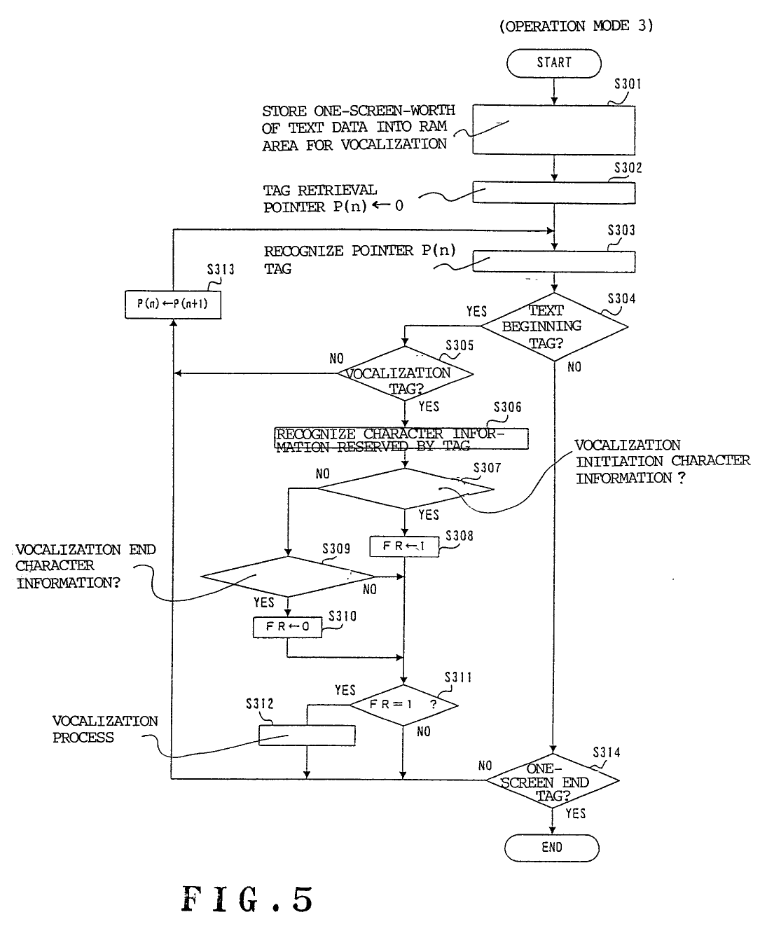

A subroutine for the operation mode 2 is illustrated in the flowchart of FIG. 4. Activation of the subroutine in the operation mode 2 is similar to that in the operation mode 1. Specifically, the subroutine may be initiated as the user presses the button for character information vocalization or the data receiving device issues an interruption command upon complete reception of the whole character data of one-screen-worth.

Incidentally, the above described operation mode 1 is a scheme that in principle vocalizes the received character information entirely, and sets in the memory unit 14 certain tags for reserving particular character information which should not be vocalized. The operation mode 2, on the contrary, does not vocalize any character information in principle, and sets in the memory unit 14 certain tags for reserving particular character information which should be vocalized.

When the flowchart of the operation mode 1 (FIG. 3) and that of the operation mode 2 (FIG. 4) are compared with each other, therefore, the only difference lies in that the determination at Step 15 in FIG. 3 differs from that at Step 25 in FIG. 4. Specifically, Step 15 in the operation mode 1 (FIG. 3) determines whether the recognized tag is a non-vocalization tag, and if the answer is no, then the vocalization process is carried out (Step 16). In the operation mode 2 (FIG. 4), on the other hand, Step 25 determines whether the recognized tag is a vocalization tag, and if the answer is yes, the vocalization process is conducted (Step 26). Accordingly, the operation in the mode 2 is substantially the same as that in the mode 1, and therefore the detailed description of the operation mode 2 is omitted and major points will be described.

In the flowchart shown in FIG. 4, the system controller 13 first stores a one-screen-worth of text data in the vocalization-specific RAM area in the memory unit 14 and then retrieves the first tag data from the stored data. If the retrieved tag data matches the predetermined vocalization tag, the character information reserved by this tag is vocalized by the voice synthesis.

Like the operation mode 1, the vocalization tag is input by the data receiving device manufacture or the user. In this embodiment, it should be assumed that the tags <TITLE> and <TD> are set as the vocalization tags.

When the character information shown in FIG. 2B is received and the process of this subroutine is carried out, the character information of “Traffic Information”, “Kawagoe”, “R-254”, “Jam”, “Omiya”, “R-16” and “Accident” is vocalized by the voice synthesis and issued to the user.

The results of this voice information output are similar to those in the operation mode 1.

Next, the operation mode 3 will be described. The operation mode 3 is an operation mode that vocalizes particular character information among the received character information on the basis of the key words which the user set in connection with the character information beforehand, and issues it as the voice signal.

The subroutine of the operation mode 3 is illustrated in the flowchart of FIG. 5. The way of activating the subroutine of the operation mode 3 and the procedure from the storage of the one-screen-worth of text data (Step 301) to the determination on whether the tag is a vocalization tag or not (Step 305) are the same as those in the operation mode 2. Therefore, the process of the operation mode 3 will be described in detail from Step 305 in the flowchart shown in FIG. 5.

If it is determined at Step 305 that the tag is a vocalization tag, the system controller 13 recognizes the character information reserved by this tag (referred to as reserved character information) (Step 306). Recognition of the character information is a procedure to check whether the reserved character information corresponds to character information which the user has set in the RAM area of the memory unit 14 beforehand. The user may directly enter the character information by operating the keyboard of the control unitl7, or may select one of a plurality of key words such as “Traffic Information”, “Weather Forecast” and “Kawagoe (name of the city)”, which the system controller 13 indicates in the display screen of the data receiving device, by operating the function keys of the control unit 17.

After the character information recognition at Step 306, the system controller 13 makes the following two determinations. First at Step 307, the system controller 13 determines whether the reserved character information is vocalization initiation character information among the already entered character information. If it is the case, the system controller 13 sets the flag register (FR) in the memory unit 14 to one (Step 308). If the answer at Step 306 is negative, on the other hand, the system controller 13 determines at Step 309 whether the reserved character information is vocalization end character information among the already entered character information. If the answer is yes, the system controller 13 resets the flag register (FR) to zero (Step 310).

The vocalization start character information is a key word representing the beginning of that part of the character information received over the digital broadcasting which the user wants to vocalize. The vocalization end character information is a key word representing the end of that part of the character information. When, therefore, the received character information of one-screen-worth is processed, the flag register (FR) is set to one from the detection of the vocalization start character information to the detection of the vocalization end character information.

The system controller 13 determines the content of the flag register (FR) at Step 311. If FR=1, the system controller 13 performs the voice synthesis process on the character information recognized at Step 306, and supplies the resultant in the form of voice signal to the voice signal processor 16 (Step 312).

In this embodiment, it should be assumed, for example, that the description format of the character information received via the digital broadcasting is the one shown in FIG. 2B, and the “Kawagoe” is registered as the vocalization start character information and “Omiya” is registered as the vocalization end character information. Then, the display screen shown in FIG. 2A is present to the user and the character information of “Kawagoe”, “R-254” and “Jam” is transformed to the voice signals by the voice synthesis and issued to the user in turn from the speaker or headphone. Thus, the user can listen to the traffic information about the desired area in the form of voice information among the traffic information of many areas in the form of character information supplied from the digital broadcasting.

If the retrieved tag is not a vocalization tag at Step 305 or FR=0 at Step 311, or after the vocalization process is complete at Step 312, then the program advances to Step 313 and the system controller 13 adds one to n of P(n) before returning to Step 303 to repeat the above described process.

Like the operation modes 1 and 2, the subroutine is terminated upon detection of the one-screen end tag in the operation mode 3 (Step 314).

In the flowchart shown in FIG. 5, only one determination process is available from the detection of the vocalization start character information to the detection of the vocalization end character information and only one flag is used in such determination process. The voice synthesis method of the present invention is, however, not limited in this regard. For instance, a plurality of determination processes and flags may be provided in tandem to repeatedly perform the process from Steps 307 to 309. This makes it possible to discretely and arbitrarily vocalize a plurality of portions in the one-screen-worth of character information.

The operation mode 4 will now be described. The operation mode 4 is an operation mode that conducts the voice synthesis on the received character information only when the received character information matches one of a plurality of key words related to the character information and one of logic conditions related to the key words, and issues it as voice signals. The key words and logic conditions are set by the user beforehand.

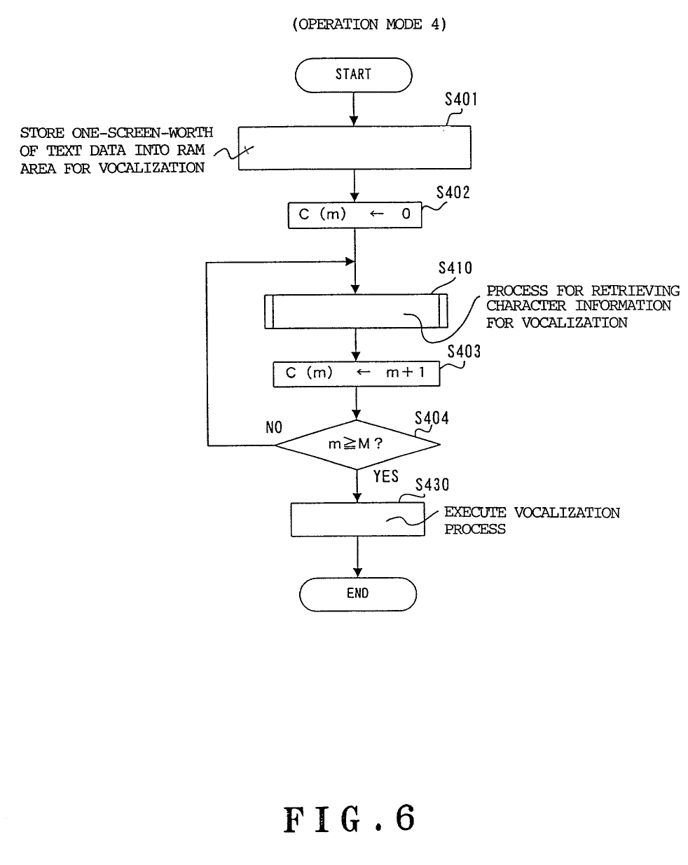

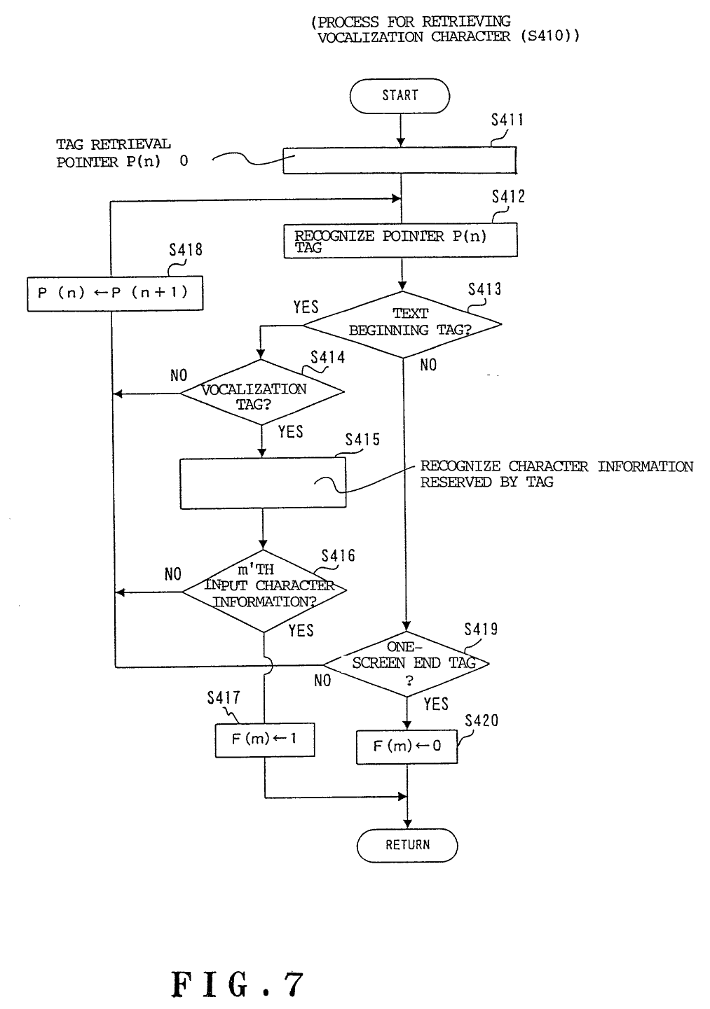

The subroutine of the operation mode 4 is illustrated in the flowcharts of FIGS. 6 and 7. The flowchart shown in FIG. 6 is a main process program of the subroutine and that shown in FIG. 7 is a sub-process program for retrieval of vocalization character information (Step 410) in the same subroutine.

In the flowchart shown in FIG. 6, the system controller 13 stores text data of one-screen-worth for vocalization into the RAM area of the memory unit 14 (Step 401), and resets an input character information counter C(m) provided in the RAM area with an initial value m=0 (Step 402).

After the initialization, the system controller 13 executes the sub-program shown in the flowchart of FIG. 7, i.e., the retrieval of character information to be vocalized (Step 410).

This sub-program retrieves particular character information, which become key words, from the received one-screen-worth of character information. Thus, the procedure from the setting of the tag retrieval pointer P(n) to the determination on whether the tag is a vocalization tag as well as the recognition of the character information reserved by the vocalization tag (Steps 411 to 415) is the same as the procedure from Steps 302 to 306 in the operation mode 3 shown in FIG. 5. It should be noted, however, that in the sub-program of FIG. 7 the reserved character information recognized at Step 415 is not determined to be an identifier that simply indicates the beginning or end of the vocalization process; rather the character information is determined to be m'th character information in the key words set by the user (Step 416).

It should be assumed here, for instance, that the user has entered three character information “Traffic Information”, “Metropolitan Highway” and “Jam” in this order as the character information retrieval key words for voice synthesis of the character information. Then, these three character information is taken as the character information entered with m=0, m=1 and m=2 respectively.

If the sub-program shown in FIG. 7 is first called out at Step 410 in the flowchart shown in FIG. 6, m=0 at Step 402 as described above. The system controller 13 therefore determines whether the recognized reserved character information is “0”th entered character information. In the above example, it determines whether the reserved character information is “Traffic Information” or not.

If the reserved character information matches the previously entered character information at Step 416, i.e., if it is “Traffic Information”, then the system controller 13 sets the entered character information flag F(m) to one (Step 417) and terminates the subroutine to return to Step 410 in the flowchart of FIG. 6. Of course, the current flag F(m) is F(0). In this example, the relationship between the entered character information and F(m) is given as follows: “Traffic Information” to F(0), “Metropolitan Highway” to F(1) and “Jam” to F(2).

When the reserved character information does not match the entered character information at Step 416 in the flowchart of FIG. 7, when the tag is not a vocalization tag at Step 414 or when the tag is not a one-screen end tag at Step 419, the system controller 13 increments the tag retrieval pointer P(n) to n+1 (Step 418) and the program returns to Step 412 to repeat the tag retrieval in the sub-program.

When it is determined at Step 413 that the tag is not a text start tag, the system controller 13 determines at Step 419 whether the text end tag is the one-screen end tag. If the answer is affirmative, the system controller resets F(m) to zero (Step 420) to terminate this sub-program and return to Step 410 in the flowchart shown in FIG. 6.

After returning from the sub-program for the vocalization character retrieval process shown in FIG. 7, the system controller 13 increments m of the counter C(m) to m+1 at Step 403 in FIG. 6. The system controller 13 then determines at next Step 404 whether a count value reaches a predetermined value M. The value of M is automatically set when the user enters the character information which is used as key words for voice synthesis. In this embodiment, three key words “Traffic Information”, “Metropolitan Highway” and “Jam” are entered so that M=3.

When it is determined at Step 404 that the count value does not reach M, the program returns to Step 410 and the system controller 13 repeats the sub-program for vocalization character information retrieval process shown in FIG. 7 until m≧M is established.

A fact that the count value m is three (M=3) at Step 404 in the flowchart of FIG. 6 and the program shifts to the subsequent vocalization process (Step 430) therefore means that the setting and resetting of the respective flags F(0), F(1) and F(2) is complete. If character information entered for a flag exist in the received character information, this flag is set to one. Otherwise, the flag is reset to zero.

In the embodiment, accordingly, if all the three words “Traffic Information”, “Metropolitan Highway” and “Jam” are included in the received character information of one-screen-worth, the flags become as follows: F(0)=1, F(1)=1 and F(2)=1.

In the operation mode 4, the vocalization of the received character information is executed at Step 430. The system controller 13 considers the setting/resetting conditions of the respective flags and the logic conditions of the flags entered by the user beforehand to decide the maner of vocalization.

For example, if the logic condition entered by the user is a logic product of F(0) to F(2), the voice synthesis is performed on the basis of the character information related to the three words “Traffic Information”, “Metropolitan Highway” and “Jam” only when all the flags are one, i.e., only when these three character information exist in the received character information. The character information related to the three words is supplied to the user in form of voice signals. If the logic condition is a logic sum of a logic product of F(0) and F(1) and that of F(0) and F(2), the voice synthesis is carried out when the two words “Traffic Information” and “Metropolitan Highway” or “Traffic Information” and “Jam” exist in the received character information.

The character information for the key words may be entered by the user who operates the keyboard or function keys of the operation unit 17, like in the case of other operation modes. Logic conditions pertinent to these key words may also be defined by, for example, operating particular function keys in connection with the entered key words.

Although the described embodiment only deals with pure character information for the sake of easier understanding, the present invention is not limited in this regard. For example, the voice synthesis may be conducted to graphic information. When the weather forecast is digitally broadcast for instance and graphic information such as a sunshine mark, a rain mark, and an arrow representing strength of wind is recognized in a weather map, then character information memorized beforehand in connection with predetermined graphic information, such as character information “Sunshine, Later Cloudy” to graphic information of sun/cloud, and character information “Relatively Strong North Wind” to graphic information of yellow north arrow, may be vocalized by the voice synthesis together with the graphics in the weather map.

This embodiment only concerns the digital broadcast receiving device itself, but the present invention is applicable to a car audio system. For example, the device may be designed to always receive digital broadcast even while the user is selecting another signal source such as a cassette tape or CD. Such signal source may be interrupted and instead character information may be vocalized when character information delivered over the digital broadcast meets predetermined conditions.

In the present invention, as described above, the tags included in the transmitted character information and the contents of the character information themselves are recognized to control the voice synthesis of character information so that it is unnecessary for a data sending party to append special commands into the character information for voice synthesis control.

In addition, since the data receiving party can arbitrarily decide whether the character information should be vocalized or not, usefulness and handiness of the data receiving device is raised.

This application is based on a Japanese patent application No. 2000-245863 which is hereby incorporated by reference.

What is claimed is:

1. A voice synthesization method for producing a synthesized sound that corresponds to character information included in transmitted information written in a programming language, the transmitted information including the character information and tags adapted to reserve the character information, the method comprising the steps of:
A) recognizing a tag in the character information;
B) comparing the tag recognized in step A with a predetermined tag; and
C) producing a synthesized sound from the character information except for character information reserved by the recognized tag only when the two tags match each other in step B.

2. A voice synthesization method for producing a synthesized sound that corresponds to character information included in transmitted information written in a programming language, the transmitted information including the character information and tags adapted to reserve the character information, the method comprising the steps of:
A) recognizing a tag in the character information;
B) comparing the tag recognized in step A with a predetermined tag; and
C) producing a synthesized sound from character information reserved by the recognized tag only when the two tags match each other in step B.

3. The voice synthesization method according to claim 1 further including at least one of the steps of starting and ending production of the synthesized sound that corresponds to the character information only when the two tags match each other in step B.

4. The voice synthesization method according to claim 1 further including the steps of:
D) recognizing a content of the character information reserved by the tag recognized in step A;
E) comparing the content of the reserved character information recognized in step D with a content of predetermined character information; and
F) at least starting or ending production of the synthesized sound that corresponds to the reserved character information when the two contents of the character information match each other in step E.

5. The voice synthesization method according to claim 4 further including the steps of:
G) comparing the reserved character information recognized in step D with a plurality of predetermined character information on the basis of predetermined logic condition; and
H) at least starting or ending production of the synthesized sound when the predetermined logic condition is met as a result of comparison in step G.

6. The voice synthesization method according to claim 2 further including at least one of the steps of starting and ending production of the synthesized sound that corresponds to the character information only when the two tags match each other in step B.

7. The voice synthesization method according to claim 2 further including the steps of:
D) recognizing a content of the character information reserved by the tag recognized in step A;
E) comparing the content of the reserved character information recognized in step D with a content of predetermined character information; and
F) at least starting or ending production of the synthesized sound that corresponds to the reserved character information when the two contents of the character information match each other in step E.

8. The voice synthesization method according to claim 7 further including the steps of:
G) comparing the reserved character information recognized in step D with a plurality of predetermined character information on the basis of predetermined logic condition; and
H) at least starting or ending production of the synthesized sound when the predetermined logic condition is met as a result of comparison in step G.
